(19) United States
(12) Patent Application Publication
(10) Pub. No.: US 2025/0138801 A1
(43) Pub. Date: May 1, 2025

(54) Method and Apparatus for Automatically Configuring and Deploying Containerized Application

(71) Applicant: Siemens Aktiengesellschaft, München (DE)

(72) Inventors: Bing Chao Tang, Shanghai (CN); Hong Yang Zhang, Shanghai (CN)

(73) Assignee: Siemens Aktiengesellschaft, München (DE)

(21) Appl. No.: 18/692,038

(22) PCT Filed: Sep. 15, 2021
(86) PCT No.: PCT/CN2021/118568

§ 371 Date: Mar. 14, 2024

(51) Int. Cl. G06F 8/61; G06F 8/30

(52) U.S. Cl. CPC G06F 8/63; G06F 8/311

(57) ABSTRACT

Teachings of the present disclosure include methods and systems for automatically configuring and deploying a containerized application. An example method includes: obtaining source code associated with a containerized application; generating an integrated configuration file based on the source code, and constructing, with the integrated configuration file, a component associated with the source code; generating an image configuration file based on the source code and the integrated configuration file, and generating, with the image configuration file, a container image associated with the source code; generating an application configuration file based on the source code, the integrated configuration file, and the image configuration file; and generating the containerized application using the application configuration file and the container image.

### CROSS-REFERENCE TO RELATED APPLICATIONS

This application is a U.S. National Stage Application of International Application No. PCT/CN2021/118568 filed Sep. 15, 2021, which designates the United States of America, the contents of which are hereby incorporated by reference in their entirety.

### TECHNICAL FIELD

The present disclosure relates to the field of computer technologies. Some embodiments of the teachings herein include methods and/or apparatus for automatically configuring and deploying a containerized application.

### BACKGROUND

In recent years, from development to deployment, a lot of emphasis has been put on edge applications of an edge device. The edge applications play an important role and bring many upper-level technologies the into field, including containerization technology (for example, a Docker technology) and artificial intelligence (AI) technology. Containerization technology is applicable to package all components and resources for general or specific software product delivery. AI technology has been widely applied in many fields such as a robot, an image-based application, and a parameter-based application.

The edge applications including an AI application are not easily implemented in the industrial field because there are many different dependency relationships, cases, and framework structures. It requires a lot of energy and time from application development to deployment to an edge device, so developers pay more attention to a function of an application and a test result. However, conventional development and deployment requires application developers to have professional knowledge of integrated configuration, image configuration, and application configuration, and to perform manual configuration, thereby increasing a threshold of application development, and resulting in low efficiency and error proneness in the whole process from the development to the deployment.

### SUMMARY

Therefore, an improved solution for configuring and deploying a containerized application is urgently needed. Conventionally, people need to put a lot of energy and time from application development to deployment to an edge device, which is error-prone and low efficient. In view of this, the present teachings include solutions for automatically configuring and deploying a containerized application.

As an example, some embodiments include a method for automatically configuring and deploying a containerized application, the method comprising: obtaining source code associated with a containerized application; generating an integrated configuration file based on the source code, and constructing, by using the integrated configuration file, a component associated with the source code; generating an image configuration file based on the source code and the integrated configuration file, and generating, by using the image configuration file, a container image associated with the source code; and generating an application configuration file based on the source code, the integrated configuration file, and the image configuration file and generating the containerized application by using the application configuration file and the container image.

As another example, some embodiments include an apparatus for automatically configuring and deploying a containerized application, the apparatus comprising: an obtaining unit, configured to obtain source code associated with a containerized application; an integrated management unit, configured to generate an integrated configuration file based on the source code, and construct, by using the integrated configuration file, a component associated with the source code; an image management unit, configured to generate an image configuration file based on the source code and the integrated configuration file, and generate, by using the image configuration file, a container image associated with the source code; and an application management unit, configured to generate an application configuration file based on the source code, the integrated configuration file, and the image configuration file, and generate the containerized application by using the application configuration file and the container image in combination.

As another example, some embodiments include a computing device comprising: a processor; and a memory, configured to store computer-executable instructions, the computer-executable instructions, when executed, causing the processor to perform one or more of the methods described herein.

As another example, some embodiments include a computer-readable storage medium storing computer-executable instructions configured to perform one or more of the methods described herein.

As another example, some embodiments include a computer program product stored in a tangible computer-readable storage medium and includes computer-executable instructions, when executed, causing at least one processor to perform one or more of the methods described herein.

### BRIEF DESCRIPTION OF THE DRAWINGS

Features, advantages, and other aspects of embodiments of the present disclosure become more apparent with reference to the accompanying drawings and the following detailed description. Several embodiments of the present disclosure are shown here in an exemplary rather than restrictive manner. In the drawings:

FIG. 1 shows an exemplary environment applicable to embodiments of the present disclosure;

FIG. 2 is a flowchart of an exemplary method for automatically configuring and deploying a containerized application incorporating teachings of the present disclosure;

FIG. 3 shows an exemplary apparatus for automatically configuring and deploying a containerized application incorporating teachings of the present disclosure; and

FIG. 4 shows an exemplary computing device for automatically configuring and deploying containerized application a incorporating teachings of the present disclosure.

### REFERENCE NUMERALS ARE AS FOLLOWS

100 environment
101 cloud
110 edge server
111 edge server
120 edge gateway
121 edge gateway
122 edge gateway
130 edge device
131 edge device
132 edge device
200 method
201 step
202 step
203 step
204 step
205 step
300 apparatus
301 obtaining unit
302 integrated management unit
303 image management unit
304 application management unit
400 computing device
401 processor
402 memory

### DETAILED DESCRIPTION

By automatically implementing the process of integrated configuration, image configuration, and application configuration from the source code, the teachings of the present disclosure can significantly save time and human resources and avoid errors, so that developers can pay more attention to a function. This may minimize a gap between the developers and the edge device, especially for individual developers who are not familiar with the deployment of the containerized application, lowering a threshold for application development and making it easier to deploy the containerized application, especially for a containerized AI application, to an edge ecosystem.

Exemplary embodiments of the teachings of the present disclosure are described below in detail with reference to the accompanying drawings. Although exemplary methods and apparatuses described below include software and/or firmware executed in hardware of other components, it should be noted that, the examples are only illustrative and should not be considered as restrictive. For example, it is considered that any or all hardware, software, and firmware components can be implemented in hardware exclusively, in software exclusively, or in any combination of hardware and software. Therefore, although the exemplary methods and apparatuses have been described below, it is easy for a person skilled in the art to understand that the examples provided are not used to limit manners for implementing the methods and apparatuses.

In addition, architectures, functions, and operations of possible implementations of methods and systems according to the example embodiments are illustrated in the flowcharts and the block diagrams of the accompanying drawings. It should be noted that functions labeled in the blocks may also occur in an order different from that as labeled in the accompanying drawings. For example, actually two blocks shown succession may be basically performed in parallel, or sometimes may be performed in an opposite order. This is determined by a related function. It should also be noted that each block in the flowcharts and/or the block diagrams, and a combination of the flowcharts and/or the blocks in the block diagrams may be implemented by using a dedicated hardware-based system for performing a specified function or operation or may be implemented by using a combination of dedicated hardware and computer instructions.

The terms “include” and “comprise” and similar terms used in this specification are open terms. That is, “include/comprise” and “are not limited to” indicates that other content may be further included. The term “based on” is “at least partially based on”. The term “one embodiment” represents “at least one embodiment”; the term “another embodiment” represents “at least one additional embodiment”, and so on.

As described above, it may take a lot of energy and time from application development to deployment of that application out to an edge device. Developers perform programming and testing on a host with a well-installed and configured component and a dependency. The developers pay more attention to the desired/required function of an application and a test result. Then, source code is pushed to a code library for continuous integration, including automatic construction and testing to check whether the application meets delivery or a requirement of delivery.

Corresponding continuous integration engineers write an integrated configuration file to configure and construct and test an environment. Before the application is deployed to the edge device, deployment engineers further need to create and configure an image configuration environment for deployment. The deployment engineers need to pay more effort to cooperate with developers of a containerized general-purpose application or a containerized AI application, to perform environment generation and dependency configuration. Finally, the deployment engineers manually deploy the containerized application to a corresponding edge device. Therefore, it may take a lot of labor and time in the whole process from the development to the deployment, which may be inefficient and error-prone. In view of this, the present disclosure provides solutions for automatically configuring and deploying a containerized application to overcome the foregoing defects in the prior art.

In this application, containerization technologies may include a Docker technology or a similar technology. For clarity and convenience, related features are described in detail below with reference to the Docker technology, but it should be understood that such description is only an example and not a limitation. The arrangement of the solution of the present disclosure is also applicable to a similar containerization technology.

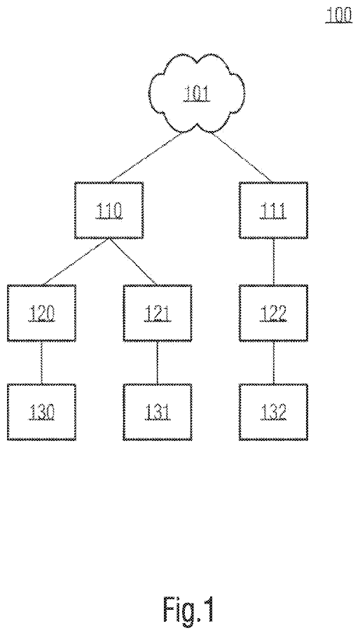

FIG. 1 shows an exemplary environment 100 applicable to the teachings of the present disclosure. The exemplary environment 100 includes a cloud 101 and a plurality of edge servers 110 and 111 connected to the cloud 101, where the cloud 100 may store, for example, various applications, images, and third-party configuration packages. The edge servers 110 and 111 are connected to the cloud 101 through a communication link (for example, a wired or wireless or hybrid link), and obtain the applications, the images, the third-party configuration packages, and the like from the cloud 101.

A plurality of communication connection devices (such as edge gateways) 120, 121, and 122 are connected between edge devices 130, 131, and 132 and the edge servers 110 and 111. Each communication connection device can implement communication between the edge device and the edge server, for example, sends an application or another file from the edge server to the edge device.

The edge device 130, 131, and 132 are devices close to a data generation apparatus (or a data source). For example, the edge device may be an industrial computer (IPC) or multifunction peripheral (MFP) with an edge capability (such as an edge computing capability), or a human-machine interaction (HMI) device, or the edge device may be, for example, a communication connection device itself of the edge gateway. By deploying the application to closer to a device of the data generation apparatus (for example, the edge device), significant benefits, such as faster insight obtained, response time reduced, and bandwidth availability improved, can be brought especially when an AI application is deployed to provide an intelligent edge node.

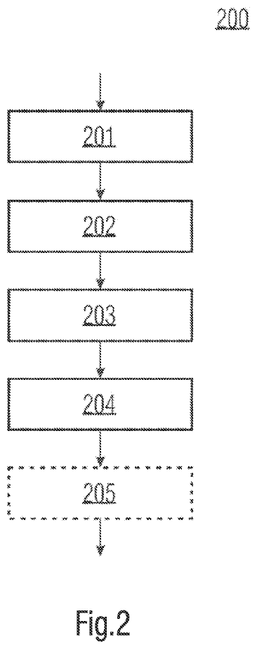

FIG. 2 is a flowchart of an exemplary method 200 for automatically configuring and deploying a containerized application incorporating teachings of the present disclosure.

Referring to FIG. 2, the method 200 starts from step 201. Step 201. Obtain source code associated with a containerized application. For example, users (for example, developers) may upload the source code associated with the containerized application to a code library or another storage device, so that the source code may be obtained from the code library or the another storage device.

Then, the method 200 proceeds to step 202. Step 202. Generate an integrated configuration file based on the source code, and construct, by using the integrated configuration file, a component associated with the source code.

Then, the method 200 proceeds to step 203. Step 203. Generate an image configuration file based on the source code and the integrated configuration file, and generate, by using the image configuration file, a container image associated with the source code.

Then, the method 200 proceeds to step 204. Step 204. Generate an application configuration file based on the source code, the integrated configuration file, and the image configuration file, and generating the containerized application by using the application configuration file and the container image. For example, one or more container images may be packaged into the containerized application by executing the application configuration file.

Different from the prior art, a configuration process of the containerized application can be automatically implemented by using the source code. The method may be automatically performed by a computer, saves time and human resources, and avoids errors, and there is no need for the developers to understand or have professional knowledge of configuration and deployment, thereby lowering a threshold for the application developers to cause the developers to pay more attention to a function of the application and a test result, and improving the working efficiency.

In some embodiments, step 202 may include: determining a type of the source code; obtaining information about a basic image and a dependency relationship from the source code; and generating the integrated configuration file based on the type of the source code and by using the information about the basic image and the dependency relationship. In this step, a type of the source code (for example, c# or angular) is first determined, to determine that information is obtained from which files of the source code (for example, project description files such as a .csproj file of c# or a .json file of angular), and grammatical content applicable to the integrated configuration file may be determined. For example, for different types of the source code, statement types configured for the basic image are different.

In some cases, formatted content of the integrated configuration file (such as grammatical content) may be generated directly based on the type of source code, or a template related to the type of the source code may be obtained from a template library to generate formatted content. Then, in this step, information about a basic image and a dependency relationship may be obtained from a file determined based on the type of the source code. The dependency relationship may represent dependency information of an environment package or a component related to the basic image. Finally, in this step, the formatted content of the integrated configuration file may be modified (such as filled) based on the type of the source code and by using the obtained information about the basic image and the dependency relationship to generate an integrated configuration file.

For example, for a continuous integration and continuous delivery (CICD) technology, the integrated configuration file is, for example, a configuration file of *.yml, generally including a plurality of stages such as prepare, build, and test, where a setting and a script of each stage may be automatically generated according to the foregoing step 202.

For example, pseudo code of source code of the exemplary type c# is as follows:

```
<PropertyGroup>
  <TargerFrameWork>netcoreappp3.1</TargerFrameWork>
</PropertyGroup>
<ItemGroup>
  <PackageReference Include=“AspNetcore” version=“4. 10.0 ”>
<ItemGroup>
```

Correspondingly, pseudo code about content of prepare in the generated integrated configuration file of the exemplary yml may be as follows:
dotnet add package AspNetcore -version 4.10.0

Similarly, content of build and test may be generated, and details are not described again.

In some embodiments, step 202 may further include: performing verification on the integrated configuration file before the constructing, by using the integrated configuration file, a component associated with the source code; checking the integrated configuration file based on a result of the verification if the verification on the integrated configuration file fails; and updating the integrated configuration file based on a result of the check and the source code. In this step, verification may be performed on the integrated configuration file by, for example, an integrated verification engine in an integrated management unit.

If the verification fails, a verification result about verification error information (such as an error type or error content) is returned, corresponding information may be then obtained from the source code based on the error type (such as image information missing or wrong or dependency relationship information missing or wrong), and the integrated configuration file is modified according to the obtained information until the integrated configuration file passes a verification test. By using this verification step, it can be ensured that the integrated configuration file is correct and meets a requirement before being deployed to the application.

In some embodiments, step 203 may include: determining a type of the source code; obtaining information about a basic image and a component from the source code and the integrated configuration file; and generating the image configuration file based on the type of the source code and by using the information about the basic image and the component. In this step, a type of the source code (for example, c# or angular) is first determined, to determine that information is obtained from which files of the source code (for example, project description files such as a .csproj file of c# or a .json file of angular) and the integrated configuration file, and grammatical content applicable to the image configuration file may be determined. For example, for different types of the source code, statement types configured for the basic image and the component are different.

In some cases, formatted content of the image configuration file (such as grammatical content) may be generated directly based on the type of source code, or a template related to the type of the source code may be obtained from a template library to generate formatted content. Then, in this step, information about the basic image and the component (image version information, component version information, component installation address information, and the like) may be obtained from the file determined based on the type of the source code and the integrated configuration file, where the information about the basic image and the component may be obtained from the source code or the integrated configuration file or from the two. Finally, in this step, the formatted content of the image configuration file may be modified (such as filled) based on the type of the source code and by using the obtained information about the basic image and the component to generate an image configuration file.

For example, for the Docker technology, the image configuration file is a dockerfile file.

For example, pseudo code of source code of the exemplary type c# is as follows:

<PropertyGroup>
<TargerFrameWork>netcoreappp3.1</TargerFrameWork>
</PropertyGroup>

Correspondingly, pseudo code of the generated exemplary image configuration file may be as follows:
apt-get install -y dotnet-sdk-3.1=3.1.1.301-1 & & \

In some embodiments, step 203 may further include: further generating the image configuration file based on one or more of an external dependency package configuration file, security enhancement information, and image cleaning information. In this step, content in the image configuration file may be added or modified based on the external dependency package configuration file (such as third-party package configuration information), so that the image may load an external dependency package. Content in the image configuration file may be added or modified based on the security enhancement information. For example, a permission of the user to use an image is restricted (such as root is deleted or a reverse proxy is used) to enhance the security. Content in the image configuration file may be added or modified based on the image cleaning information to reduce the size of the image. For example, unnecessary components and installation packages are removed, so that the size of the image can be well adapted to the storage and processing capacity of the edge device.

In some embodiments, step 203 may further include: performing verification on the image configuration file before the generating, by using the image configuration file, a container image associated with the source code; checking the image configuration file based on a result of the verification if the verification on the image configuration file fails; and updating the image configuration file based on a result of the check, the source code, and the integrated configuration file.

In this step, verification may be performed on the image configuration file by, for example, an image verification engine in an image management unit. If the verification fails, a verification result about verification error information (such as an error type or error content) is returned, corresponding information may be then obtained from the source code and the integrated configuration file based on the error type (such as image information missing or wrong or component information missing or wrong), and the image configuration file is modified according to the obtained information until the image configuration file passes a verification test. By using this verification step, it can be ensured that the image configuration file is correct and meets a requirement before being deployed to the application.

In some embodiments, step 204 may include: obtaining information about a basic image, image push, and an image service port from the source code, the integrated configuration file, and the image configuration file; and generating the application configuration file by using the information about the basic image, the image push, and the image service port. In this step, information about a basic image (for example, image name information), information about image push (for example, pushed address information), and information about an image service port (for example, port address information) may be obtained from the source code, the integrated configuration file, and the image configuration file, and an application configuration file is generated by using these information.

For example, for the Docker technology, the application configuration file is, for example, a configuration file of docker-compose .yml, and pseudo code of the exemplary docker-compose file may be as follows:

```
services:
  api_service:
    Image:ai_api_ci: v1.1.1;
    Ports: 5001:5001
  gui_service:
    Image:ai_gui_ci: v1.1.1;
    Ports: 4200:4200
```

In the application configuration file, two images are designated to be packaged into the containerized application, and a corresponding service port is assigned or designated. The information about the images and the service port may come from one or more of the source codes, the integrated configuration file, and the image configuration file.

In some embodiments, step 204 may further include: performing verification on the application configuration file before the generating the containerized application by using the application configuration file and the container image in combination; checking the application configuration file based on a result of the verification if the verification on the application configuration file fails; and updating the application configuration file based on a result of the check, the source code, the integrated configuration file, and the image configuration file. In this step, verification may be performed on the application configuration file by, for example, an application verification engine in an application management unit.

If the verification fails, a verification result about verification error information (such as an error type or error content) is returned, corresponding information may be then obtained from the source code, the integrated configuration file, and the image configuration file based on the error type (such as image information missing or wrong or service port information missing or wrong), and the application configuration file is modified according to the obtained information until the application configuration file passes a verification test. By using this verification step, it can be ensured that the application configuration file is correct and meets a requirement before being deployed to the application.

In some embodiments, the method 200 may further include step 205: deploying the containerized application to an edge device. In this step, final application deployment can be implemented based on the foregoing automated configuration process.

In some embodiments, step 205 may include at least one of the following: sending the application configuration file to the edge device, so that the edge device generates the containerized application; or pushing the generated containerized application to the edge device. In this step, the edge device (for example, a client of the edge device) may receive the application configuration file and generate the containerized application by executing the application configuration file, or the edge device may receive a push message of the containerized application, and the edge server, the cloud, or the like pushes the application to the edge device.

In some embodiments, the containerized application is an AI application. For example, foregoing the containerized application may be the AI application, such as an image recognition application based on machine learning, and required information of components such as a camera and/or a sensor is configured in the configuration file by using the foregoing steps, so that the generated containerized application may include the use or invocation of these components.

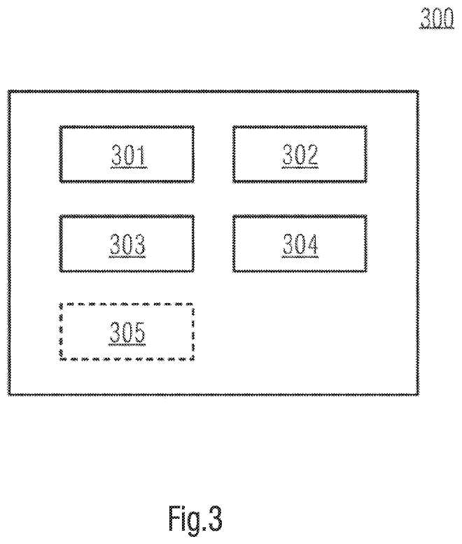

FIG. 3 shows an exemplary apparatus 300 for automatically configuring and deploying a containerized application incorporating teachings of the present disclosure. Referring to FIG. 3, the apparatus 300 includes an obtaining unit 301, an integrated management unit 302, an image management unit 303, and an application management unit 304.

The obtaining unit 301 is configured to obtain source code associated with a containerized application.

The integrated management unit 302 is configured to generate an integrated configuration file based on the source code, and construct, by using the integrated configuration file, a component associated with the source code.

The image management unit 303 is configured to generate an image configuration file based on the source code and the integrated configuration file, and generate, by using the image configuration file, a container image associated with the source code.

The application management unit 304 is configured to generate an application configuration file based on the source code, the integrated configuration file, and the image configuration file, and generate the containerized application by using the application configuration file and the container image in combination.

In some embodiments, the integrated management unit 302 may be configured to: determine a type of the source code; obtain information about a basic image and a dependency relationship from the source code; and generate the integrated configuration file based on the type of the source code and by using the information about the basic image and the dependency relationship.

In some embodiments, the integrated management unit 302 may be further configured to: perform verification on the integrated configuration file before the constructing, by using the integrated configuration file, a component associated with the source code; check the integrated configuration file based on a result of the verification if the verification on the integrated configuration file fails; and update the integrated configuration file based on a result of the check and the source code.

In some embodiments, the image management unit 303 may be configured to: determine a type of the source code; obtain information about a basic image and a component from the source code and the integrated configuration file; and generate the image configuration file based on the type of the source code and by using the information about the basic image and the component.

In some embodiments, the image management unit 303 may be further configured to: further generate the image configuration file based on one or more of an external dependency package configuration file, security enhancement information, and image cleaning information.

In some embodiments, the image management unit 303 may be further configured to: perform verification on the image configuration file before the generating, by using the image configuration file, a container image associated with the source code; check the image configuration file based on a result of the verification if the verification on the image configuration file fails; and update the image configuration file based on a result of the check, the source code, and the integrated configuration file.

In some embodiments, the application management unit 304 may be configured to: obtain information about a basic image, image push, and an image service port from the source code, the integrated configuration file, and the image configuration file; and generate the application configuration file by using the information about the basic image, the image push, and the image service port.

In some embodiments, the application management unit 304 may be further configured to: perform verification on the application configuration file before the generating the containerized application by using the application configuration file and the container image in combination; check the application configuration file based on a result of the verification if the verification on the application configuration file fails; and update the application configuration file based on a result of the check, the source code, the integrated configuration file, and the image configuration file.

In some embodiments, the apparatus 300 may further optionally include a deployment unit 305. The deployment unit 305 may be configured to: deploy the containerized application to an edge device.

In some embodiments, the deployment unit 305 may be configured to perform at least one of the following: send the application configuration file to the edge device, so that the edge device generates the containerized application; or push the generated containerized application to the edge device.

In some embodiments, the containerized application is an AI application.

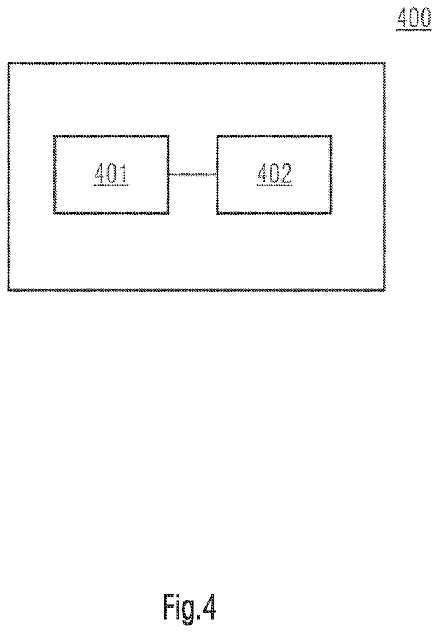

FIG. 4 is a block diagram of an exemplary computing device 400 for automatically configuring and deploying a containerized application incorporating teachings of the present disclosure. The computing device 400 includes a processor 401 and a memory 402 coupled to the processor 401. The memory 402 is configured to store computer-executable instructions, the computer-executable instructions, when executed, causing the processor 401 to perform the methods in the foregoing embodiment (for example, any one or more steps in the foregoing method 200).

The solution for automatically configuring and deploying a containerized application as described in the foregoing embodiments may have the following advantages: The whole process from a development end to deployment to an edge end has better performance and higher efficiency; the developers can pay more attention to a function, and more easily deploy the containerized application, especially for the containerized AI application, to an edge ecosystem; before deployment, all unnecessary components and installation packages may be cleaned during installation, and a security enhancement behavior may be adjusted according to a deployed product; the system can reduce time consumed by the developers or deployers during integration and deployment and minimize the workload, thereby improving the working efficiency and also effectively lowering a development threshold; in addition, the system can make a great contribution to the edge ecosystem, minimize a gap between the developers and the edge device, especially for individual developers who are not familiar with the deployment of the containerized application, and reduce the time and energy consumed from the development to the deployment, so that the edge device is deployed in a factory faster and more powerfully.

In some embodiments, the method can be implemented by using a computer-readable storage medium. The computer-readable storage medium stores computer-readable program instructions that are configured to perform one or more of the methods incorporating teachings of the present disclosure. The computer-readable storage medium may be a tangible device that can retain and store instructions used by an instruction execution device. The computer-readable storage medium may be, for example, but is not limited to, an electrical storage device, a magnetic storage device, an optical storage device, an electromagnetic storage device, a semiconductor storage device, or any appropriate combination of the above.

In a more specific example (a non-exhaustive list), the computer-readable storage medium includes a portable computer disk, a hard disk, a random access memory (RAM), a read-only memory (ROM), an erasable programmable read-only memory (EPROM or flash memory), a static random access memory (SRAM), a portable compact disc read-only memory (CD-ROM), a digital versatile disk (DVD), a memory stick, a floppy disk, a mechanical coding device such as a punched card or protrusion in a groove in which instructions are stored, and any appropriate combination of the above. The computer-readable storage medium used here is not explained as a transient signal itself, such as a radio wave or other electromagnetic waves propagated freely, an electromagnetic wave propagated through a waveguide or other transmission media (for example, a light pulse propagated through an optical fiber cable), or an electrical signal transmitted through a wire.

In some embodiments, a non-transitory computer-readable storage medium stores computer-executable instructions, the computer-executable instructions configured to perform one or more of the methods incorporating teachings of the present disclosure.

In another embodiment, a computer program product stored in a tangible computer-readable storage medium, and includes computer-executable instructions, the computer-executable instructions, when executed, causing at least one processor to perform one or more of the methods incorporating teachings of the present disclosure.

Generally, the exemplary embodiments of the present disclosure can be implemented in hardware or a dedicated circuit, software, firmware, logic, or any combination thereof. Some aspects can be implemented in hardware, while other aspects can be implemented in firmware or software executable by a controller, a microprocessor, or other computing devices. When aspects of the embodiments of the present disclosure are illustrated or described as block diagrams, flowcharts, or represented by some other graphs, it should be understood that the blocks, apparatuses, systems, technologies, or methods described herein can be implemented, as non-restrictive examples, in hardware, software, firmware, a dedicated circuit or logic, general-purpose hardware or a controller or other computing devices, or some combinations thereof.

The computer-readable program instructions or computer program product for implementing the embodiments of the present disclosure can also be stored in a cloud, and when invocation is necessary, a user can access the computer-readable program instructions stored in the cloud and configured to implement an embodiment of the present disclosure through a mobile Internet, a fixed network, or other networks, thereby implementing the technical solutions disclosed according to the embodiments of the present disclosure.

Although the embodiments of the present disclosure have been described with reference to several specific embodiments, it should be understood that the embodiments s of the present disclosure are not limited to the disclosed specific embodiments. The embodiments of the present disclosure are intended to cover various updates and equivalent arrangements included within the spirit and scope of the appended claims. The scope of the claims conforms to the broadest interpretation and thus includes all such updates and equivalent structures and functions.

What is claimed is:

1. A method for automatically configuring and deploying a containerized application, the method comprising:
obtaining source code associated with a containerized application;
generating an integrated configuration file based on the source code, and constructing, with the integrated configuration file, a component associated with the source code;
generating an image configuration file based on the source code and the integrated configuration file, and generating, with the image configuration file, a container image associated with the source code;
generating an application configuration file based on the source code, the integrated configuration file, and the image configuration file; and
generating the containerized application using the application configuration file and the container image.

2. The method according to claim 1, wherein generating an integrated configuration file based on the source code comprises:
determining a type of the source code;
obtaining information about a basic image and a dependency relationship from the source code; and
generating the integrated configuration file based on the type of the source code and by using the information about the basic image and the dependency relationship.

3. The method according to claim 1, further comprising:
performing verification on the integrated configuration file before the constructing, by using the integrated configuration file, a component associated with the source code;
checking the integrated configuration file based on a result of the verification if the verification on the integrated configuration file fails; and
updating the integrated configuration file based on a result of the check and the source code.

4. The method according to claim 1, wherein generating an image configuration file based on the source code and the integrated configuration file comprises:
determining a type of the source code;
obtaining information about a basic image and a component from the source code and the integrated configuration file; and
generating the image configuration file based on the type of the source code and by using the information about the basic image and the component.

5. The method according to claim 4, further comprising
generating the image configuration file based on one or more of an external dependency package configuration file, security enhancement information, and image cleaning information.

6. The method according to claim 1, further comprising:
performing verification on the image configuration file before the generating, by using the image configuration file, a container image associated with the source code;
checking the image configuration file based on a result of the verification if the verification on the image configuration file fails; and
updating the image configuration file based on a result of the check, the source code, and the integrated configuration file.

7. The method according to claim 1, wherein generating an application configuration file based on the source code, the integrated configuration file, and the image configuration file comprises:
obtaining information about a basic image, image push, and an image service port from the source code, the integrated configuration file, and the image configuration file; and
generating the application configuration file by using the information about the basic image, the image push, and the image service port.

8. The method according to claim 1, further comprising:
performing verification on the application configuration file before the generating the containerized application by using the application configuration file and the container image in combination;
checking the application configuration file based on a result of the verification if the verification on the application configuration file fails; and
updating the application configuration file based on a result of the check, the source code, the integrated configuration file, and the image configuration file.

9. The method according to claim 1, further comprising deploying the containerized application to an edge device.

10. The method according to claim 9, wherein deploying the containerized application to an edge device comprises at least one of the following:
sending the application configuration file to the edge device, so that the edge device generates the containerized application; or
pushing the generated containerized application to the edge device.

11. The method according to claim 1, wherein the containerized application comprises an artificial intelligence application.

12. An apparatus for automatically configuring and deploying a containerized application, the apparatus comprising:
an obtaining unit to obtain source code associated with a containerized application;
an integrated management unit to generate an integrated configuration file based on the source code, and construct, by using the integrated configuration file, a component associated with the source code;
an image management unit to generate an image configuration file based on the source code and the integrated configuration file, and generate, by using the image configuration file, a container image associated with the source code; and
an application management unit to generate an application configuration file based on the source code, the integrated configuration file, and the image configuration file, and generate the containerized application by using the application configuration file and the container image in combination.

13. The apparatus according to claim 12, wherein the integrated management unit is further configured to:
determine a type of the source code;
obtain information about a basic image and a dependency relationship from the source code; and
generate the integrated configuration file based on the type of the source code and by using the information about the basic image and the dependency relationship.

14. The apparatus according to claim 12, wherein the integrated management unit is further configured to:
perform verification on the integrated configuration file before the constructing, by using the integrated configuration file, a component associated with the source code;
check the integrated configuration file based on a result of the verification if the verification on the integrated configuration file fails; and
update the integrated configuration file based on a result of the check and the source code.

15. The apparatus according to claim 12, wherein the image management unit is configured to:
determine a type of the source code;
obtain information about a basic image and a component from the source code and the integrated configuration file; and
generate the image configuration file based on the type of the source code and by using the information about the basic image and the component.

16. The apparatus according to claim 15, wherein the image management unit is configured to:
further generate the image configuration file based on one or more of an external dependency package configuration file, security enhancement information, and image cleaning information.

17. The apparatus according to any one of claim 12, wherein the image management unit is further configured to:
perform verification on the image configuration file before the generating, by using the image configuration file, a container image associated with the source code;
check the image configuration file based on a result of the verification if the verification on the image configuration file fails; and
update the image configuration file based on a result of the check, the source code, and the integrated configuration file.

18. The apparatus according to claim 12, wherein the application management unit is configured to:
obtain information about a basic image, image push, and an image service port from the source code, the integrated configuration file, and the image configuration file; and
generate the application configuration file by using the information about the basic image, the image push, and the image service port.

19. The apparatus according to claim 12, wherein the application management unit is further configured to:
perform verification on the application configuration file before the generating the containerized application by using the application configuration file and the container image in combination;
check the application configuration file based on a result of the verification if the verification on the application configuration file fails; and
update the application configuration file based on a result of the check, the source code, the integrated configuration file, and the image configuration file.

20. The apparatus according to claim 12, further comprising
a deployment unit to deploy the containerized application to an edge device.

21. The apparatus according to claim 12, wherein the deployment unit is configured to perform at least one of the following:
send the application configuration file to the edge device, so that the edge device generates the containerized application; or
push the generated containerized application to the edge device.

22. The apparatus according to claim 12, wherein the containerized application is an AI application.

23. A computing device comprising:
a processor; and
a memory storing computer-executable instructions, the computer-executable instructions, when executed, causing the processor to
obtain source code associated with a containerized application;
generate an integrated configuration file based on the source code, and constructing, with the integrated configuration file, a component associated with the source code;
generate an image configuration file based on the source code and the integrated configuration file, and generating, with the image configuration file, a container image associated with the source code;
generate application configuration file based on the source code, the integrated configuration file, and the image Configuration file; and
generate the containerized application using the application configuration file and the container image.

24. A non-transitory computer-readable storage medium storing computer-executable instructions configured to cause a processor to:
obtain source code associated with containerized application;
generate an integrated configuration file based on the source code, and constructing, with the integrated configuration file, a Component associated with the source code;
generate an image configuration file based on the source code and the integrated configuration file, and generating, with the image configuration file, container image associated with the source code;
generate an application configuration file based on the source code, the integrated configuration file, and the image configuration file; and
generate the containerized application using the application configuration file and the container image.

25. (canceled)
